(19) United States
(12) Patent Application Publication
(10) Pub. No.: US 2006/0240395 A1
(43) Pub. Date: Oct. 26, 2006

(54) System and method for coaching

(76) Inventors: Allyson Lee Faist, Houston, TX (US); David Robert McCormick JR., Houston, TX (US); Jeffery Dale Myers, Houston, TX (US)

Correspondence Address: CONLEY ROSE, P.C., P. O. BOX 3267, HOUSTON, TX, 77253-3267, US

(21) Appl. No.: 11/410,617

(22) Filed: Apr. 25, 2006

Related U.S. Application Data
(60) Provisional application No. 60/674,636, filed on Apr. 25, 2005.

(51) Int. Cl. G09B 3/00

(52) U.S. Cl. 434/322

(57) ABSTRACT

Coaching methods and systems are provided in which assessment data is received from a user, the assessment data is used along with course selection rules to select a plurality of courses for the user, and a plurality of electronic messages comprising content of the plurality of courses is sent to the user on a scheduled basis.

### CROSS-REFERENCE TO RELATED APPLICATIONS

This specification claims the benefit of U.S. Provisional Patent Application Ser. No. 60/674,636, filed Apr. 25, 2005, entitled “System and Method for Coaching.”

### STATEMENT REGARDING FEDERALLY SPONSORED RESEARCH OR DEVELOPMENT

Not applicable.

### BACKGROUND

Many business enterprises are interested in creating a healthier and more productive workplace. To that end, these enterprises have begun providing various support programs for their employees to encourage improved lifestyles. These support programs may include various things such as routine health screenings, generic brochures about various lifestyle issues, and on line access to generic lifestyle-related information.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIGS. 1 and 2 illustrate architectures of a coaching system in accordance with one or more embodiments.

FIG. 3 shows a flow diagram of a coaching method in accordance with one or more embodiments.

FIGS. 4-8 and 10A-10D show illustrative user interface displays of a coaching system in accordance with one or more embodiments.

FIG. 9 shows an illustrative course email in accordance with one or more embodiments.

FIGS. 11A-11E show an illustrative aggregate report of a coaching system in accordance with one or more embodiments.

FIG. 12 shows an illustrative computer system suitable for implementing a coaching system in accordance with some embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Additionally, the term “system” refers to a collection of two or more parts and may be used to refer to a computer system or a portion of a computer system. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be illustrative of that embodiment, and not intended to intimate that the scope of the disclosure, including the claims, is limited to that embodiment.

Inasmuch as the systems and methods described herein were developed in the context of health improvement coaching, the embodiments described herein are drawn from that context. However, the discussion of the various systems and methods in relation to health improvement coaching should not be construed as a limitation as to the applicability of the systems and methods described herein to only health improvement coaching. One of ordinary skill in the art will appreciate that these systems and methods may also be implemented in any coaching environment, such as career coaching, job coaching, and sports performance improvement.

Embodiments of the present disclosure provide methods and systems for coaching. In some embodiments, a web-based health improvement coaching system is provided that uses network technology to deliver individualized coaching programs to encourage individuals to improve lifestyle habits. The users of the heath improvement coaching system may include employees (and their family members), companies (i.e., providers) that are paying for their employees to use the system, and health coaches that that provide telephonic and email coaching to the employees. These health coaches may be employed by the companies or by a coaching service provider who is providing the health improvement coaching system to the companies.

In some embodiments, an employee registers with the health improvement coaching system by entering profile information and completing an on-line lifestyle assessment form. The health improvement coaching system then selects programs and courses for the employee based assessment data derived from the profile information and the lifestyle assessment entries. The employee may review the selections made by the system and further customize the selection of programs and courses. The health improvement coaching system then automatically generates course electronic messages (e.g., email messages) based on the selected courses, i.e., each course electronic message includes a lesson from a selected course, and sends them to the employee on a scheduled basis.

The health improvement coaching system also provides each employee with an individual web page that allows the user to do such things as update the lifestyle assessment and profile information, review and change course and program selections, track progress, etc. This employee home page includes a HIPAA (“Health Insurance Portability and Accountability Act”) compliant secure interface through which the employee may interact with a health coach for additional assistance if the employee is having difficulty achieving goals or has questions not answered in the course material. Some embodiments may also include an interface with online forums and group postings where the employee may garner peer support through interactions with other users such as sharing stories, trading recipes, and passing on helpful advice. Through this interface, the employee may be, at the employee's request, matched up one or more other users of the system (i.e., a buddy or buddies) for more personal interaction based on common interests and/or health improvement goals.

In addition to the customized electronic coaching and live coaching for employees, embodiments of the health improvement coaching system also include a reporting interface for providers and coaching tools for the health coaches. Company personnel may use the reporting interface to view aggregate reports of such things as employee demographic participation, lifestyle assessment results, and biometric progress. The coaching tools allow the health coaches to do such things as monitor and track employees registered with the health improvement coaching system, schedule coaching appointments, provide quick response to employee questions, and select additional programs and courses for an employee.

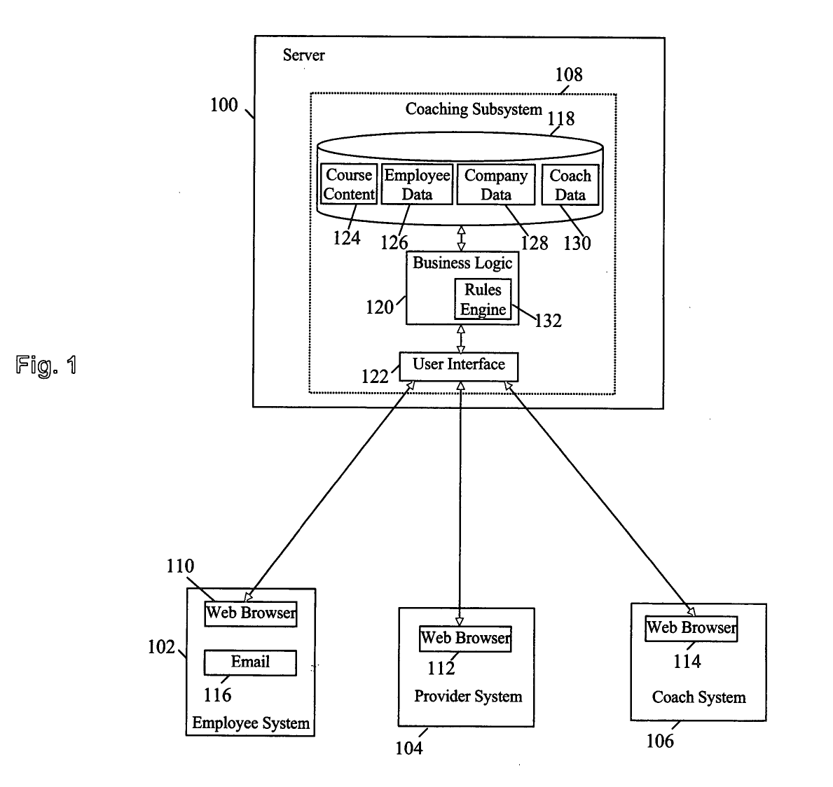

FIG. 1 illustrates a health improvement coaching system in accordance with one or more embodiments. The health improvement coaching system includes a server 100, an employee system 102, a provider system 104, and a coach system 106 connected via a network (not specifically shown). While only one employee system 102, provider system 104, and coach system 106 is illustrated for simplicity of explanation, the coaching system may include multiple of each system as needed. The network may be a local area network (LAN), a wide area network (WAN), a telephone network, an intranet, the Internet, a wireless network, or a combination of networks.

The server 100 may be any commercially available server system configured to interface with the user system 102, provider system 104, and coach system 106 over the network and may be configured to execute any commercially available server operating system including versions of Windows®, HP-UX, Solaris, and Linux. Windows is a registered trademark of Microsoft Corporation. The server 100 includes a coaching subsystem 108 that communicates with the user system 102, provider system 104, and coach system 106 over the network. While a single server 100 is illustrated for simplicity of explanation, the health improvement coaching system may include multiple servers, and the functionality of the coaching subsystem 108 may be distributed and load balanced across these servers.

The employee system 102, provider system 104, and coach system 106 may be any commercially available personal computing system configured to interface with the server 100 over the network. Examples of such computing systems include personal computers, laptops, personal digital assistants (PDAs), and cell phones. The employee system 102, provider system 104, and coach system 106 may be configured to execute any commercially available operating system for a personal computer including versions of Windows®, HP-UX, and Solaris.

The employee system 102, provider system 104, and coach system 106 include web browsers 110, 112, 114, respectively. These web browsers 110, 112, 114 may be any commercially available web browser compatible with the operating system installed on the individual systems (e.g., Internet Explorer, Firefox, Opera, and Safari). The employee system 102 also includes an email application 116. The email application 116 may be a separate software program (e.g., Microsoft Outlook) or may be accessed via the web browser 110 (e.g., Yahoo! Mail). Other applications (not specifically shown) capable of receiving text messages via the network (e.g., instant messaging or text messaging) may also be included in the employee system 102 as an alternative to or in conjunction with the email application 116.

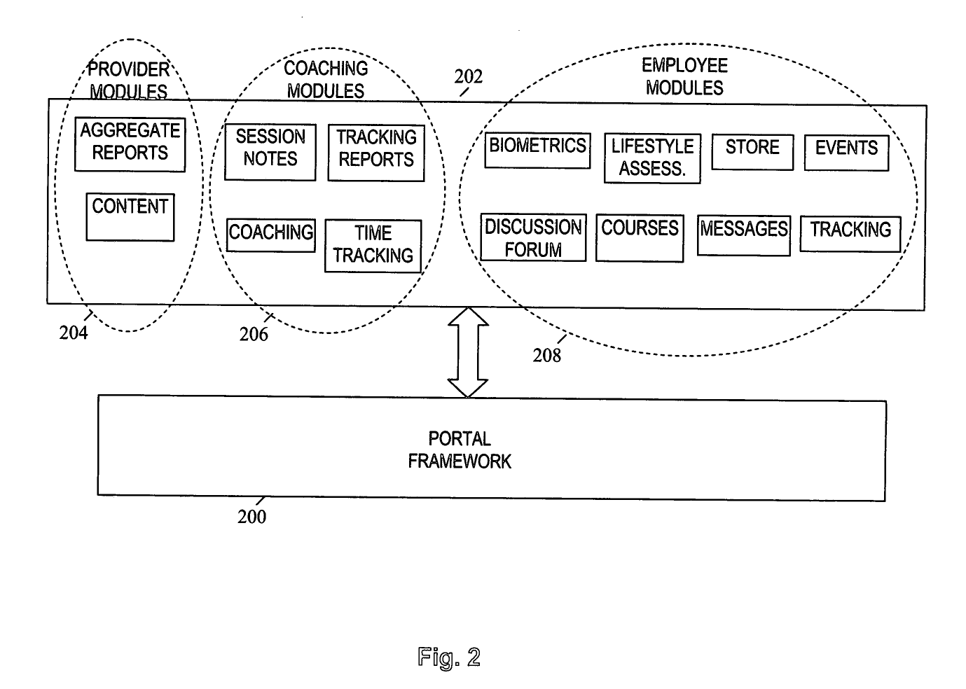

In some embodiments, the coaching subsystem 108 comprises a tiered application architecture including a database tier 118, a business logic tier 120, and a presentation tier (i.e., user interface 122). The user interface 122 provides the graphical user interface functionality between the employee system 102, the provider system 104, and the coach system 106 and the coaching subsystem 108. The user interface 122 includes functionality to present an employee user interface in the web browser 110 of the employee system 102, a provider user interface in the web browser 112 of the provider system 104, and a coaching interface in the web browser 114 of the coaching system 106. These interfaces may comprise web forms for handling the display and management of data produced by the business logic tier 120 to a user (e.g., a health coach, employee, or employer representative). These web forms, in some embodiments, are implemented as ASP.NET dynamically populated controls that present the data to the users or request that the users provide data. In other embodiments, the functionality of the user interface 122 may be implemented in other suitable programming languages such as Java Server Page (JSP), Servlet, Active Server Page (ASP), ASP.NET, Perl and PHP. Embodiments of these interfaces are described in more detail in reference to FIGS. 2-11E below.

The business logic tier 120 contains the business rules (e.g., coaching logic and business logic for managing the portal and associated web services) and data manipulation functionality of the coaching subsystem 108. In one or more embodiments, the business tier logic utilizes Microsoft's Internet Information Server (IIS) to handle incoming requests and to host the ASP.NET controls. The business logic tier 120 may be implemented in C#.NET and VB.NET and interoperates with the IIS to manage and coordinate the execution of the business rules. In other embodiments, the business logic tier 120 may be implemented in other programming languages including Java, JavaScript, J#, C, C++, ActionScript, XSL, XQuery, and XPath, among others.

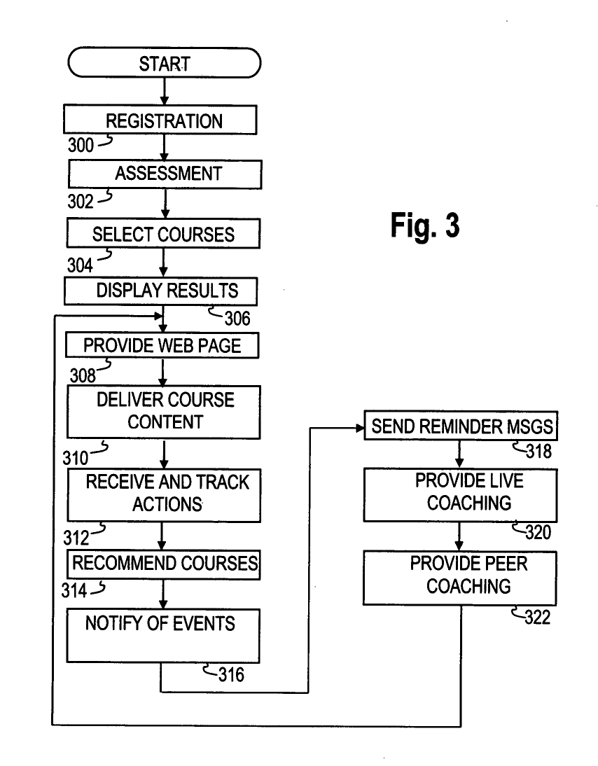

The business logic tier 120 includes a forward-chaining rules engine 132 that applies course selection rules derived from the expert knowledge of health care professionals to select relevant health improvement coaching for employees. For example, the rules engine 132 may match employee health data and profile information to course content to select course options relevant to the health risks and interests of the employee. These course selection rules may be stored as XML files in a file system of the server 100 or in a database comprised in the database tier 118. The functionality of embodiments of the rules engine 132 is described in more detail in reference to FIGS. 3-9 below.

The database tier 118, which may comprise Microsoft SQL Server or another suitable database management system, provides the functionality to store and retrieve, among other things, the course content 124, employee data 126, company data 128, and health coach data 130 of the coaching subsystem 108. The course content 124 includes the content for the available health management courses. These health management courses comprise practical, researched health information based on current medical research. The employee data 126 includes information such as the current profile and lifestyle assessment data, the current course selections, and current action tracking status for each registered employee. The company data 128 includes information such as contract data and number of registered employees for each company purchasing health management coaching for its employees. The coach data 130 includes information such as customer relationship management data, time tracking data, and task management data for each health coach.

FIG. 2 further illustrates the architecture of the coaching subsystem 108 in accordance with some embodiments. In these embodiments, the coaching subsystem 108 may be implemented as a web portal including a web portal framework 200 and various portal content modules 204, 206, 208 that execute on top of the portal framework 200. The portal framework 200 provides the basic functionality of a web portal including such things as security, user management, navigation management, store administration, report administration, content management, and plug in capability for the portal content modules 204, 206, 208. In addition, the portal framework 200 implements the rules engine 132.

The portal content modules 204, 206, 208 are comprised of various individual modules that each include user controls that may be combined to create web page interfaces to the functionality generally indicated by the names of the individual modules. That is, the provider modules 204 comprise user controls for implementing web page interfaces to aggregate reporting functionality and content management functionality that may be displayed in the web browser 112 of the provider system 104. Similarly, the coaching modules 206 and employee modules 208 comprise user controls for implementing web page interfaces to functionality represented by the named individual modules that may be displayed, respectively, in the web browsers 110, 114 of the employee system 102 and the coach system 106. The illustrated named content modules in the portal content modules 204, 206, 208 are presented by way of example only and are not intended to limit the scope of this disclosure. Other content modules may be included or the functionality represented by each module may be grouped differently.

FIG. 3 shows a flow diagram of a coaching method that may be implemented in the health improvement coaching system of FIGS. 1 and 2. Although the actions of this method are presented and described serially, one of ordinary skill in the art will appreciate that the order may differ, actions illustrated as being separate may be combined, not all actions are necessarily required, and/or some of the actions may occur in parallel or periodically. The method begins with the registration of a user (e.g., an employee or a member of an employee's family) (block 300). In some embodiments, when an employer contracts with a health management coaching service provider for coaching services for employees and their family members, these potential users are notified via email that the coaching services are available. This email may include a link to the health improvement coaching web portal (e.g., coaching subsystem 118) and a registration code. The potential user then begins the coaching process by clicking on the link or typing the URL of the coaching web portal into a web browser (e.g., web browser 110). The potential user is then presented with a web page asking for a user id and a registration code. The potential user enters a user id corresponding to an email address and the registration code provided in the notification email to complete the registration process.

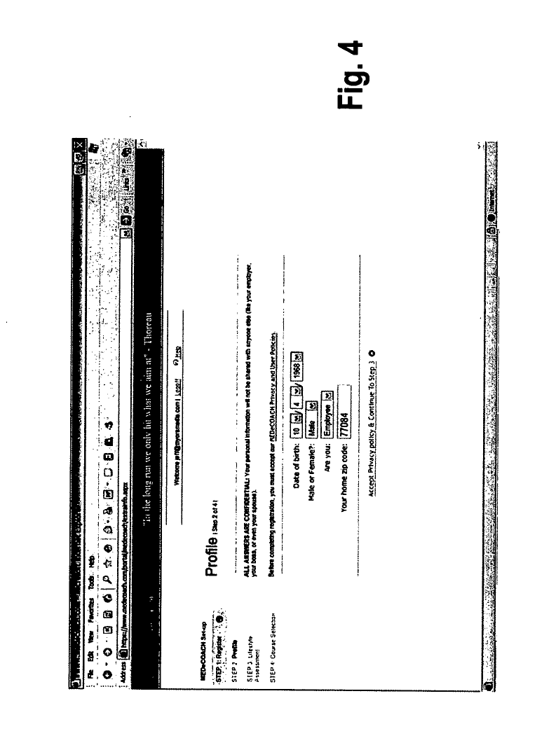

The new user is then presented with a profile web page, an example of which is shown in FIG. 4. This profile page asks for certain demographic information about the user including date of birth, gender, relationship to the providing company, and home zip code. This profile page also presents the user with the opportunity to review and accept the privacy and user policies of the health improvement coaching service provider.

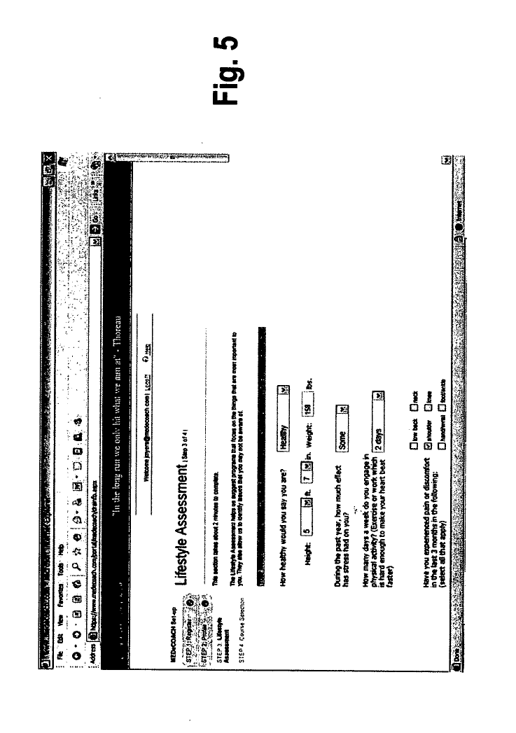

Once the user completes the profile and indicates acceptance of the privacy and user policies, the user is asked to complete a lifestyle assessment questionnaire (block 302). An example of a web page displaying a portion of such a questionnaire is shown in FIG. 5. In some embodiments, this lifestyle assessment questionnaire is designed to identify such things as common health conditions, physical activity level, preventive screening results (e.g., blood pressure and cholesterol levels), pain points, and behaviors and barriers to good health. More specifically, this lifestyle assessment questionnaire elicits information regarding twelve health risk areas: body mass index (“BMI”), personal health rating, stress level, physical activity level, pain/discomfort level, tobacco use, alcohol consumption, cholesterol level, blood pressure, job satisfaction, safety, amount of sleep, eating habits, social support, and recent personal losses.

Once the lifestyle assessment questionnaire is completed, the rules engine 132 uses information taken from the profile data and the assessment questionnaire in combination with a set of course selection rules to select a custom set of programs and/or individual courses from the course content 124 targeted to identified health risks and/or opportunities to improve overall health. A program is a predefined set of courses and/or programs related to a particular health improvement topic such as managing stress, eating healthier, or having more energy.

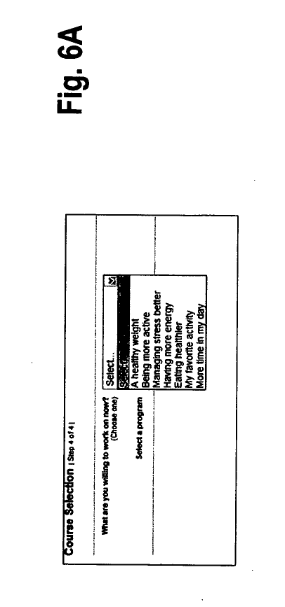

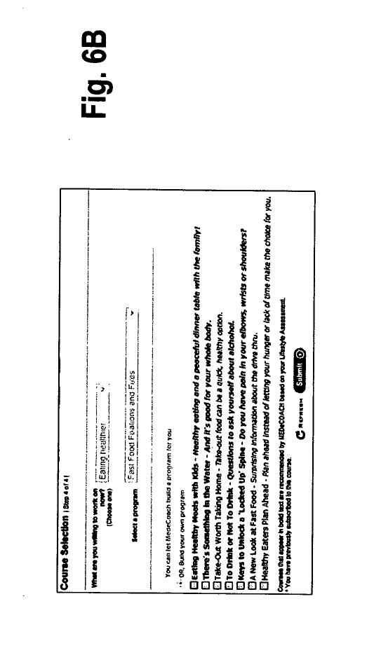

The user is then presented with course selection options (block 304) based on the selected programs. An example of a course selection display is shown in FIG. 6A. In the illustrated embodiment, the user is asked to select only one of the identified areas to work on. Once the user selects an area to work on, for example “Eating healthier”, the user is presented with program selection options as well as the option to select individual courses as illustrated in the example course selection display of FIG. 6B.

The user is first presented with a list of programs related to the selected program (not specifically shown) and asked to select one of those programs. In the example of FIG. 6B, the user has selected a program entitled “Fast Food Fixations and Fixes.” The user is then offered the option of accepting the program course content selected by the rules engine 132 or customizing the selected program. As is shown in the example of FIG. 6B, if the user opts to customize the selected program, a list of the courses comprising that program are displayed so that the user may select which courses the user wants to take. The courses shown in bold type are the courses in the selected program chosen by the rules engine 132 for the user based on the user's lifestyle assessment results while those shown in normal typeface are other available courses in the selected program.

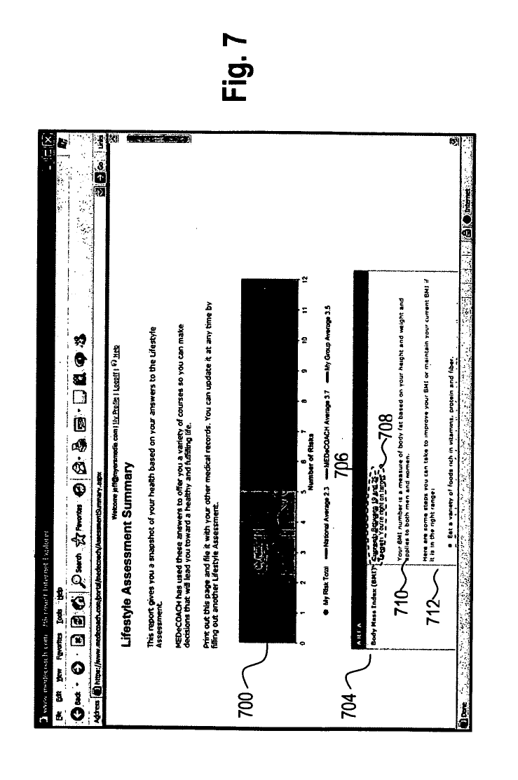

After the user has selected and possibly customized a program, the coaching subsystem 108 schedules the delivery of the course material to the user. The user is also presented with summary results of the lifestyle assessment (block 306). An example of a web page displaying a portion of such a lifestyle assessment summary is shown in FIG. 7. This summary page includes a bar graph 700 in which the scale is 1 to 12 representing the number of risk areas assessed. The number of risk areas in which the user is considered to be “at risk” is added up and displayed as a point 702 on the bar graph 770. Following the bar chart 700 is a table 704 including a row for each of the twelve assessed risk areas. The user's results for each risk area are summarized in the form of a current assessment 706, a recommended target 708, a summary explanation 710 of the risk area, and some recommended actions 712 the user can take to decrease the risk.

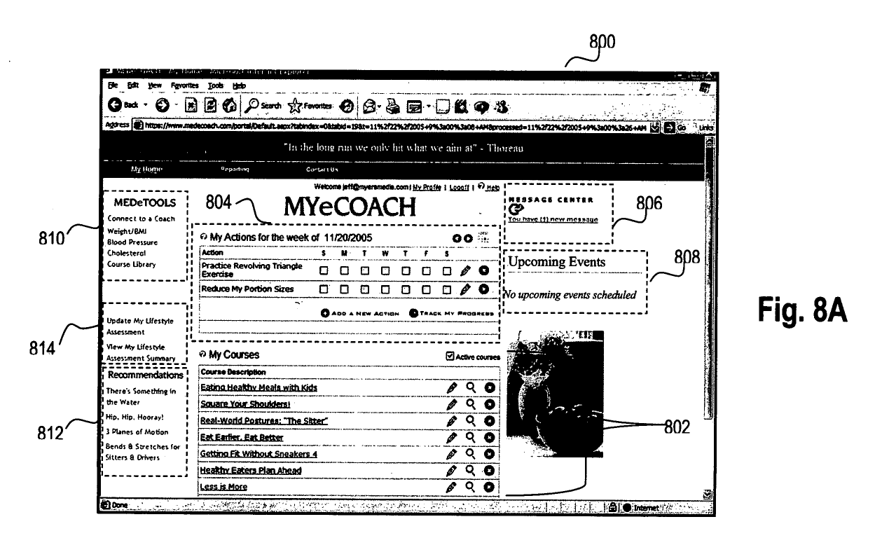

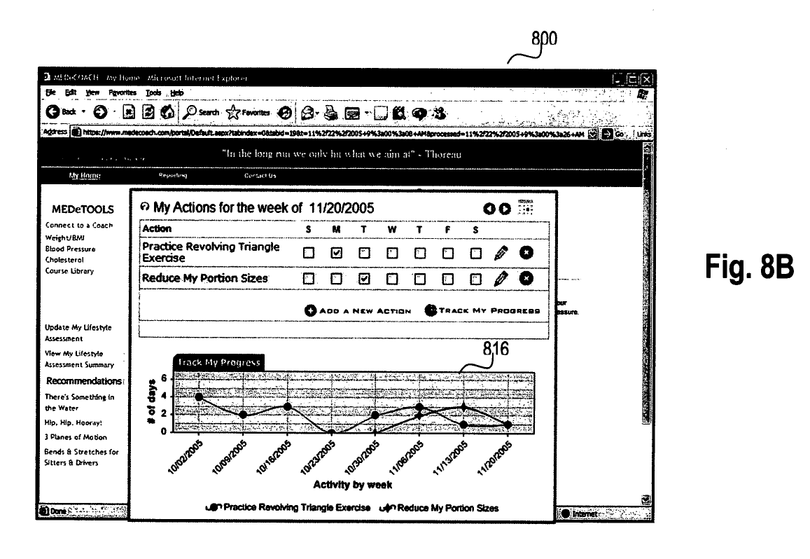

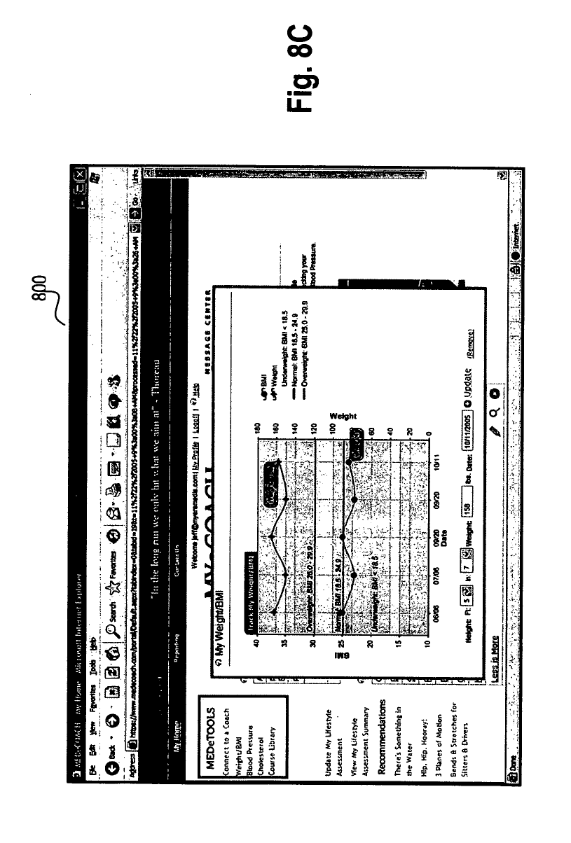

Once the user has completed the registration process, the remainder of the coaching activities (blocks 308-322) may occur as needed to provide the user with health improvement coaching. A personalized coaching home page is provided for the user (block 308) as the user's primary interface to the coaching web portal. A link (i.e., URL, not specifically shown) at the bottom of the summary web page allows the user to navigate to the user's coaching home page. The user's coaching home page is also provided to the user each time the user logs into the coaching web portal. FIG. 8 shows an example of such a personalized coaching home page 800.

In some embodiments, the user's coaching home page 800 includes a course management user control 802, an action tracking user control 804, a message center user control 806, an event notification user control 808, a tools user control 810, a recommendations user control 812, and an assessment user control 814. In some embodiments, the coaching home page 800 may also include user controls (not specifically shown) for an online store and/or user discussion forums. The course management user control 802 presents the user with a list of the courses the user is scheduled to receive and allows the user manage this course list. The course management user control 802 includes functionality allowing the user to view each course in the course list, to add or delete a course, and to make notes related to each listed course. The course management user control 802 also contains functionality allowing the user to start a different program. If the user elects to start a different program, the user repeats the course selection process described in relation to FIGS. 6A and 6B. When the user completes the course selection processes, any changes are reflected in the course list presented by the course management user control 802.

The action tracking user control 804 presents the user with a list of the actions (i.e., healthy behaviors) the user has elected to track. An action may be, for example, “Practice Revolving Triangle Exercise” or “Reduce My Portion Sizes.” The action tracking user control 804 includes functionality allowing the user to track healthy behaviors (i.e., actions) suggested in the course material or any other action the user wishes to track by “checking off” each day the user practices an action. Actions may be added to this list via links in the course material selected by the user. The action tracking user control 804 also includes functionality allowing the user create custom action tracking entries.

By default, a seven-day action tracking snapshot for the current week is displayed in the coaching web page 800. The action tracking user control 804 includes functionality allowing the user to navigate to tracking snapshots for a previous week or a future week and to remove an action from the list. This user control also allows the user to view a graphical summary of progress for each action by week. FIG. 8B shows an example 816 of such a graphical summary.

The message center user control 806 includes functionality allowing the user to send, receive, and manage messages between the user and a health coach. This user control also notifies the user of new messages. The event notification user control 808 presents the user with a list of currently scheduled events and includes functionality allowing the user to view additional information about a listed event and to register for a listed event.

The tools user control 810 includes functionality allowing the user to track personal biometrics including weight/BMI, blood pressure, cholesterol level, and glucose/HBA1C levels. If the user selects one of the listed options, the user is presented with a display allowing the user to enter data relevant to the selected biometric. The screen may also include a graphical chart showing changes in the biometric over time. FIG. 8C shows an example of a display for tracking weight/BMI. The tools user control 810 also include functionality allowing the user to view the entire course library and to contact a health coach.

The recommendations user control 812 presents the user with a list of courses recommended by the rules engine 132 and not currently included in the user's scheduled courses. This user control includes functionality allowing the user to preview the listed courses and optionally add a recommended course to the user's scheduled courses. If the user elects to add a recommended course to the user's scheduled courses, the selected recommended course is removed from the recommended list and added to the course list provided by the course management user control 802.

The assessment user control 814 includes functionality allowing the user to update the user's lifestyle assessment questionnaire and to view the user's lifestyle assessment summary. If the user makes changes to the user's lifestyle assessment summary, the rules engine 132 may update the custom set of programs selected for the user to reflect these changes. These updates may change the list of recommended courses displayed by the recommendations user control 812. These updates may also change the options presented to the user when the user chooses to start a new program as previously described here.

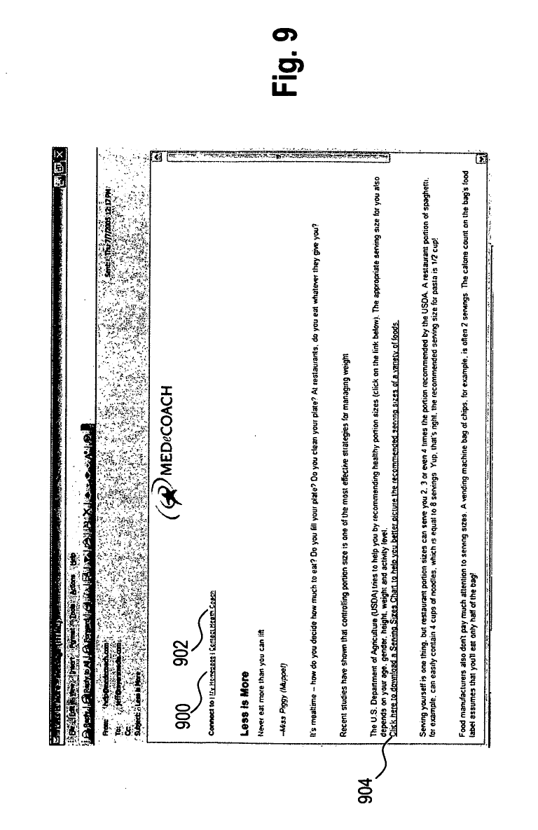

The coaching subsystem 108 automatically generates and delivers the scheduled course content (block 310) to the user via email. In some embodiments, the course content is configured into short, action oriented lessons intended to engage the recipient in learning and practicing new healthy skills and actions. FIG. 9 shows an example course email. Each course email may include a URL 900 for the user's coaching home page 800 and a URL 902 for contacting a health coach. Some courses may also include one or more URLs 904 for accessing relevant supplementary material. For example, in the portion control lesson shown in FIG. 9, the URL 904 allows the user to access a serving size chart. Course emails may also include an action URL (not specifically shown) that the user may click to automatically add an action related to the course to the user's action list on the user's coaching home page 800.

The coaching subsystem may periodically receive and track actions selected or defined by the user (block 312). A user may cause an action to be added to the user's action list on the user's coaching home page 800 by automatically by clicking on an action URL in a course email sent to the user. The user may also add a custom action to the action list using the functionality available to the user in the action tracking user control 804 on the user's coaching home page 800. The user may then “check off” days that the user practiced the actions in the action list to track progress. The rules engine 132 may monitor the status of the actions the user is tracking and cause the coaching subsystem to generate coaching emails (i.e., electronic coaching messages) to encourage the user and/or to suggest actions to replace existing actions as the user progresses.

The coaching subsystem 108 may also periodically recommend new courses to the user (block 314). The rules engine 132 may monitor the course content 124 for new courses that are relevant to the user as determined from the user's current lifestyle assessment data, and recommend one or more of these new courses to the user. Any courses recommended by the rules engine 132 for the user are added to the list displayed by the recommendations user control 812 on the user's coaching home page 800.

The coaching subsystem 108 may periodically notify the user of health-related events that the user may choose to attend (block 316). Events may be added to the coaching subsystem 108 by health coaches and by other users. These events may be defined with an associated date, time, location, description, and/or a maximum attendance. A user may enroll for an event by selecting the link corresponding to the event in the event list displayed by the event notification user control 808 on the user's coaching home page 800. Once the registration count for an event reaches this maximum attendance, the coaching subsystem 108 may automatically removed the event from the event lists displayed to users.

In some embodiments, the coaching subsystem 108 may periodically send email to users to remind the users of recommended health screenings and tests (e.g., mammograms, colonoscopys) relevant to the user (block 318). For example, during National Breast Cancer Awareness Month, the coaching subsystem 108 may send an email to all female users over the age of 50 an email about breast cancer awareness and reminding them of the recommended timing for mammograms for women in their age group. Or, the coaching subsystem 108 may send an email to a user on the user's 50^{th} birthday with information about colon cancer and reminding the user that a baseline colonoscopy is recommended at the age of 50. Data and rules regarding the recommended screenings and tests and timing of various national and local awareness campaigns may be maintained in the database tier 118. The rules engine 132 periodically uses the data and rules, and the current profile and lifestyle assessment results of the users to generate and send relevant reminder emails to the users.

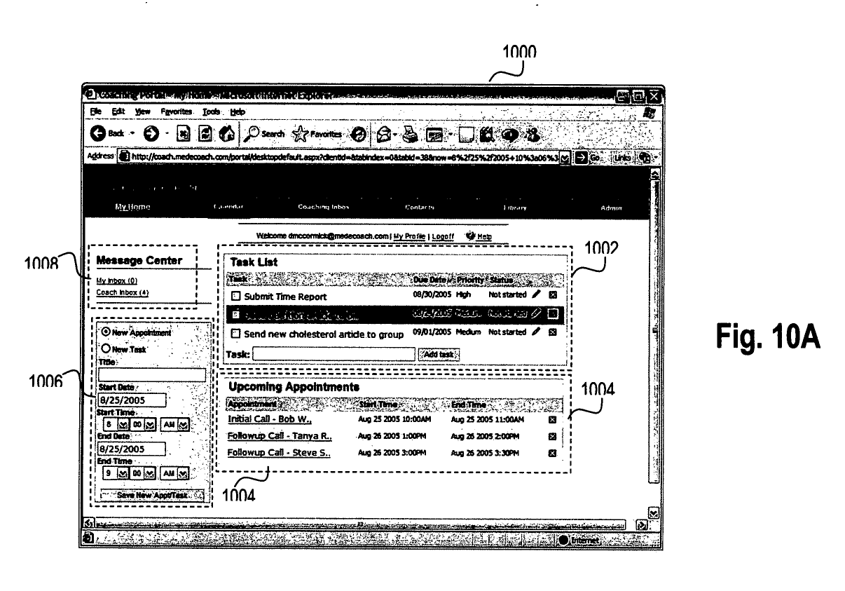

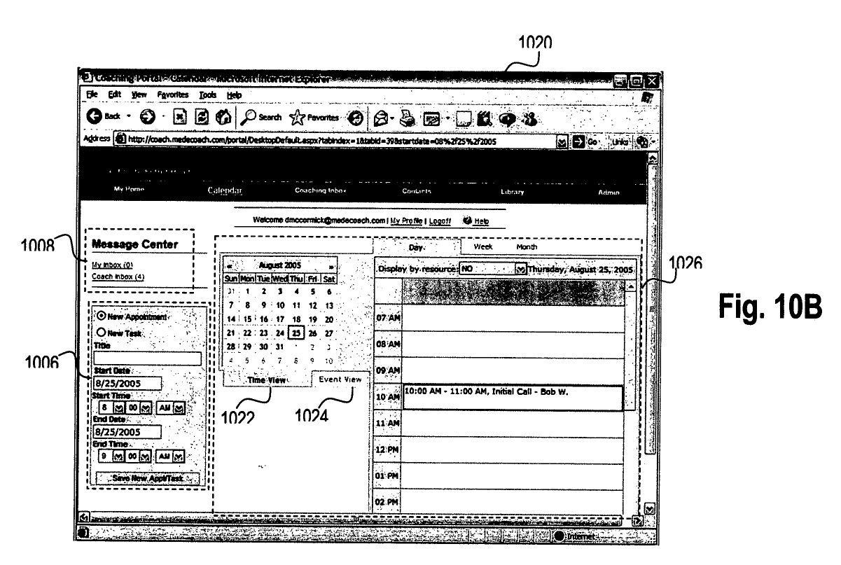

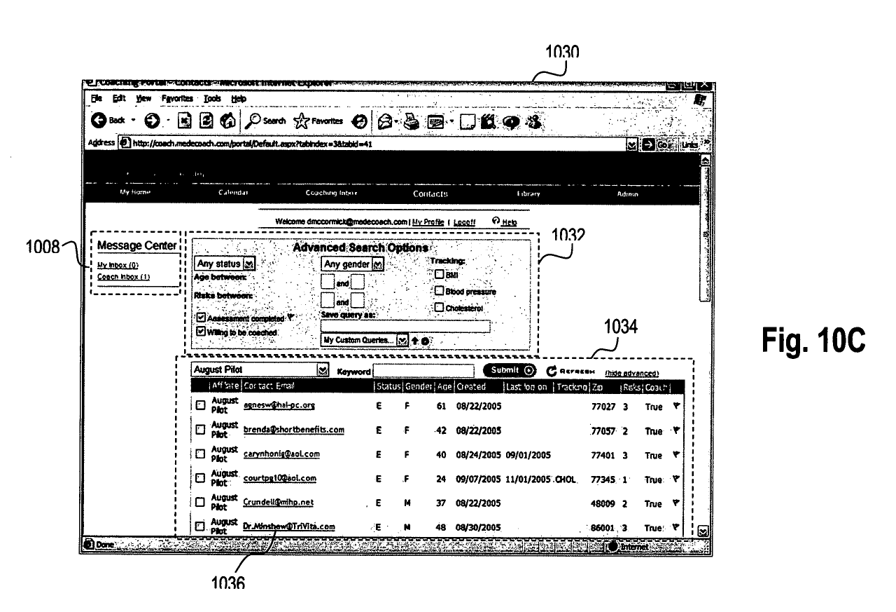

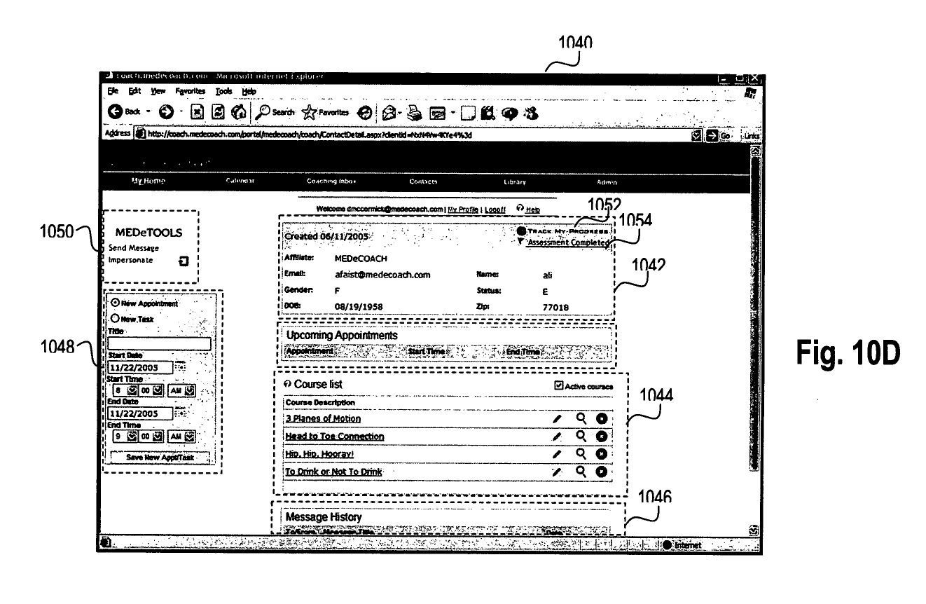

In one or more embodiments, live coaching is provided to users of the health improvement coaching system (block 320). A user may request support from a heath coach by selecting the link to coach contact tool displayed by the tools user control 810 on the user's coaching home page 800. Upon selecting this link, the user is presented with a form for composing and sending a secure message to the user's assigned coach. Reply messages from the health coach are placed in the user's inbox that the user may access via a link displayed by the message center user control 806 on the user's coaching home page 800. The coaching subsystem 108 may also notify the user via email or text messaging that a message has been placed in the user's inbox. When a user requests help from a health coach, the health coach may use various coaching tools provided by the coaching subsystem (described in more detail in relation to FIGS. 10A-10D below) to review information about the user (e.g., the user's lifestyle assessment results, current courses, and tracked actions). The health coach may interact with the user through the secure messaging system and/or telephonic correspondence, depending on the needs of the user.

The coaching subsystem 108 includes tools to support the activities of a health coach. These tools include a coach home page, a calendar tool, and client management tools. A coach home page is provided to a health coach via the web browser 114 of the coach system 106 (FIG. 1) as the coach's primary interface to the coaching web portal. From this home page, the health coach may access the other available coaching tools. FIG. 10A shows an illustrative coach home page 1000 in according to some embodiments. The coach home page includes a task management user control 102, a schedule management user control 1004, a scheduling user control 1006, and a coach message center user control 1008. The coach home page also includes a calendar link 1010 for accessing the coach's calendar tool, and a contact link 1012 for accessing the coach's client management tools. The coach home page 1000 may also include a timesheet user control (not specifically shown).

The task management user control 1002 includes functionality to display a list of the coach's currently scheduled tasks and to manage tasks. The functionality for managing tasks may include adding, deleting, or modifying a task, setting a task priority, and tracking the status of task. The schedule management user control 1004 includes functionality to display a list of the coach's upcoming appointments. The schedule management user control 1004 also includes functionality allowing the coach to remove an appointment from the list. The descriptive name of an appointment 1014 may be a link that, if selected, causes a calendar tool web page (described below) to be displayed showing the appointment on the coach's calendar.

The scheduling user control 1006 includes functionality to add a new task to the coach's task list or a new appointment to the coach's calendar. This functionality allows the coach to specify a title, start date, start time, end date, and end time for a new appointment or task. When the new appointment or task is saved, the coaching subsystem 108 causes the schedule management user control 1004 to update the displayed list of upcoming appointments or the task management user control 1002 to update the displayed list of tasks.

The coach message center user control 1008 includes functionality allowing the coach to access a messaging system to send, receive, and manage messages between the health coach and users of the health improvement coaching system. This user control also notifies the coach of new messages. The messaging system included in the coaching subsystem 108 provides functionality similar to that of known email systems for sending, receiving, and managing messages. The message system may also include a library of message templates containing responses to common questions that a coach may use when responding to user messages.

FIG. 10B shows an illustrative web page interface 1020 to the coach calendar tool in accordance with some embodiments. This web page 1020 is presented to the coach when the coach selects the calendar link 1010 on the coach home page 1000. This web page includes the coach message center control 1008, the scheduling control 1006, and a calendar control 1026. The calendar control 1026 includes calendar management functionality allowing a coach to see daily, weekly, or monthly views of the coach's calendar when in time view 1022 mode or to schedule events when in event view mode 1024.

FIGS. 10C and 10D show illustrative web page interfaces 1030 and 1040 to the client management tools in accordance with some embodiments. The client management web page 1030 is presented to the coach when the coach selects the contacts link 1012 on the coach home page 1000. The client management web page 1030 may include the coach message center control 1008, a query user control 1032, and a client list user control 1034. The query tool user control 1032, which may have both a basic search view and an advanced search view, includes functionality allowing the coach to search the employee database 126 using various search criteria. The results of the search may a list of users meeting the specified search criteria. This list is displayed by the client list user control 1034. The client list user control 1034 includes functionality allowing the coach to filter the listed clients by some predefined criteria or by keyword, and to selectively add one or more of the listed clients to work groups. The coach may click on a client contact email entry (e.g., entry 1036) to navigate to a client dashboard web page 1040 (FIG. 10D).

FIG. 10D shows an illustrative client dashboard web page 1040 in accordance with some embodiments. This client dashboard web page 1040 provides the coach with a snapshot of the coaching status of an individual client and/or links to access more detailed information about that client. The coach dashboard web page 1040 may include a client information user control 1042, an upcoming appointments user control 1044, a course customization user control 1044, a message history user control 1046, a client scheduling user control 1048, a client tools user control 1050, and a client notes user control (not specifically shown).

The client information user control 1042 includes functionality to display client's profile information, to provide a link 1052 to permit the coach to view the results of the client's lifestyle assessment, and a link 1054 to allow the coach to view the status of the actions the client has elected to track. The client scheduling user control 1048 includes functionality allowing the coach to schedule appointments and create task lists specific to the client. The upcoming appointment user control 1044 includes functionality to display a list of the coach's upcoming appointments with the client and to allow the coach to access additional information regarding an appointment in the list. The course customization user control 1044 includes functionality to display a list of the courses for which the client is currently schedules and to allow the coach to add or delete courses.

The message history user control 1046 includes functionality to display a summary of the message exchange between the coach and the client and to allow the coach to access additional details regarding any message in the list. The client tools user control 1050 includes functionality allowing the coach to send a secure message to the client and to impersonate the client. This latter impersonation functionality allows the coach to access the client's coaching home page as if the coach was the client. The client notes user control includes functionality allowing the coach to record notes regarding various interactions with the client.

Referring again to FIG. 3, in one or more embodiments, the coaching subsystem 108 provides support for peer coaching (block 322) in the form of such things as online discussion forums where users may contact with others interested in health improvement and the provision of buddy matching. Through the discussion forums, users may share stories, trade recipes, and pass on helpful advice. User controls may be included in the coaching subsystem 108 allowing users to join existing discussion forums and/or start new discussion forums. User controls may also be included to allow forum leaders to monitor all postings and discussion groups. User controls may also be included in the coaching subsystem 108 to allow a user to request a buddy (i.e., another user) that has one or more common interests and/or health improvement goals and who is willing to provide peer support. In some embodiments, these user controls may present the user with a short questionnaire in which the user expresses the criteria to be used for locating a buddy. The coaching subsystem 108 then uses these criteria (i.e., buddy request data) to match the user with another user of the system that has indicated common criteria and a willingness to communicate with others to provide peer support. In other embodiments, the user controls may present the user with an interface for requesting a buddy, and if the user so requests, the rules engine 132 uses buddy selection rules along buddy request data derived from the user's current assessment data and current action tracking status to match the user with a buddy.

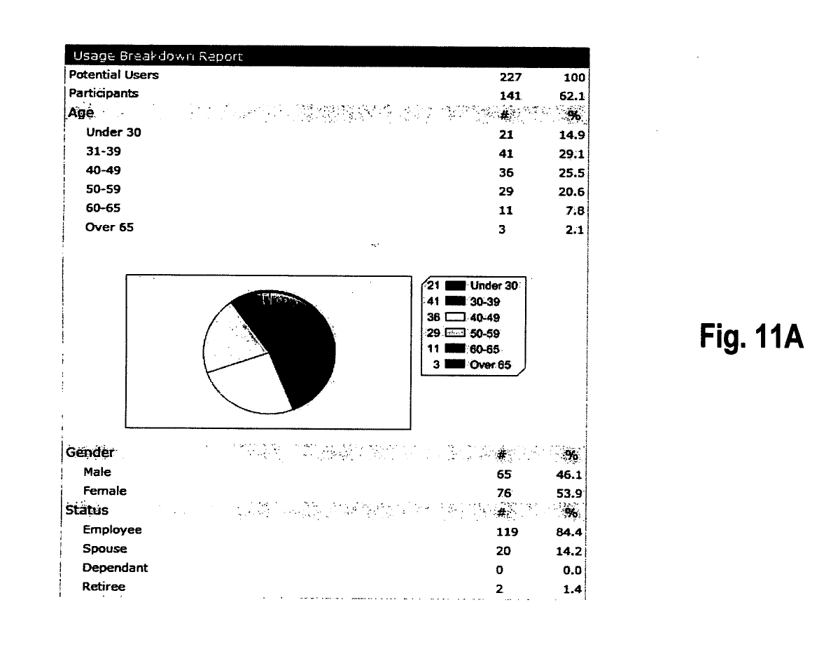

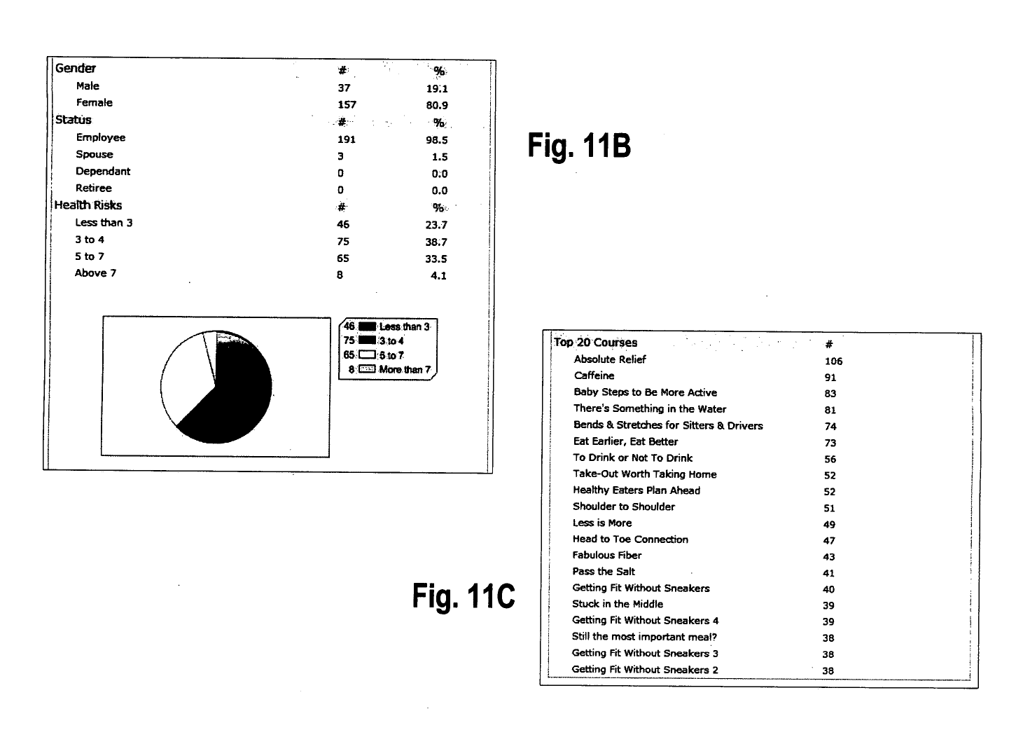

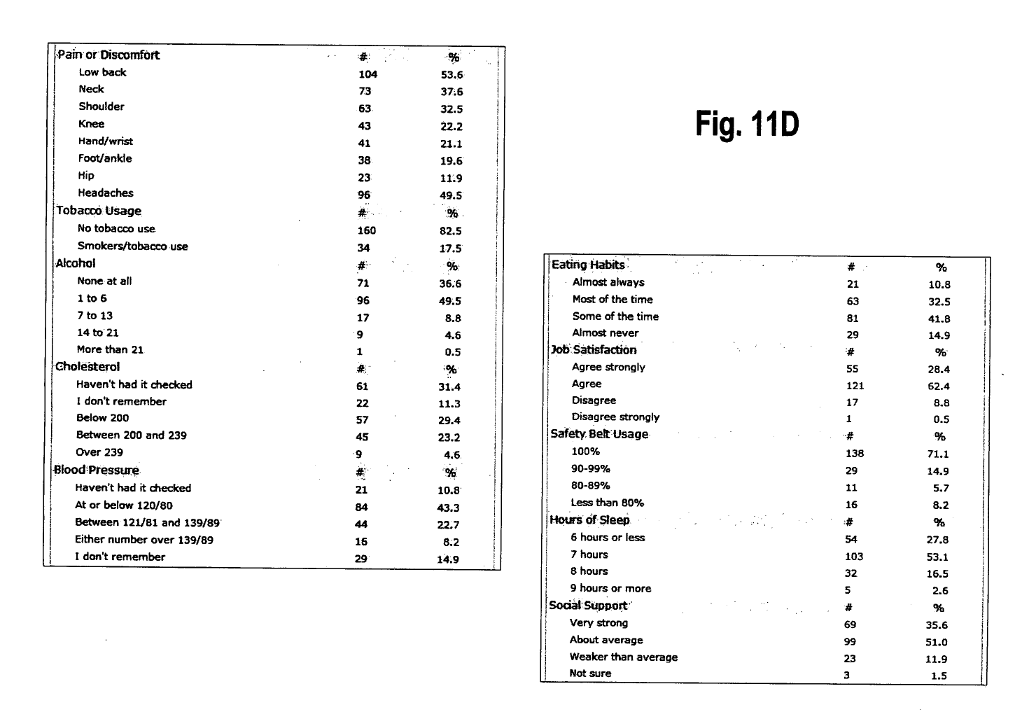

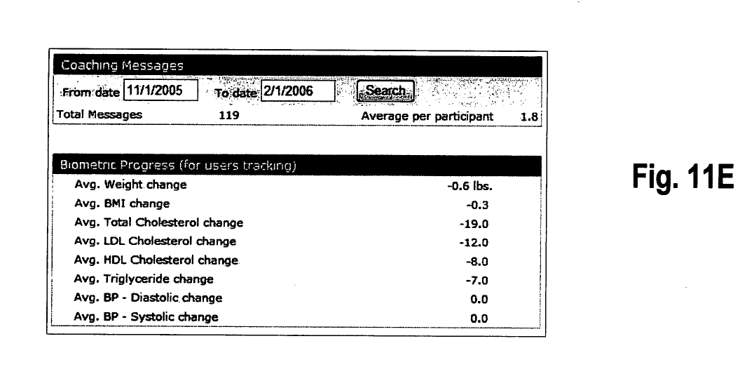

In some embodiments, the coaching subsystem 108 includes functionality (e.g., an employer web page) allowing employers (i.e., providers) to view reports to gauge the success of the overall health management coaching program through review of participation, population progress, and changes in biometric statistics like BMI. These reports may be aggregate in nature to preserve employee confidentiality and to conform to HIPAA requirements. FIGS. 11A-11E show an illustrative aggregate report. The reports may include a usage breakdown report (FIGS. 11A and 11B) that shows participation in health improvement coaching broken out by various demographics and a list of the top twenty courses taken (FIG. 11C). The available reports may also include a lifestyle assessment breakdown report showing the aggregated responses of the company's users to each item in the lifestyle assessment questionnaire. A portion of such a report is shown in FIG. 11D. In addition, the available reports may include a a health coach interaction report such as a coaching messages summary including such information as the the average number of messages per user received from health coaches during a specified time period, and a biometric progress report showing information such as average change for a specified time period across the user population in biometric statistics such as BMI, weight, blood pressure, cholesterol levels, etc. Examples of such reports are shown in FIG. 11E.

One or more embodiments of the coaching subsystem 108 may include tools allowing employers to manage the content available to their users. Using these tools, an employer may, among other things, add new courses available only to that employer's users, send broadcast messages, and create and manage a store.

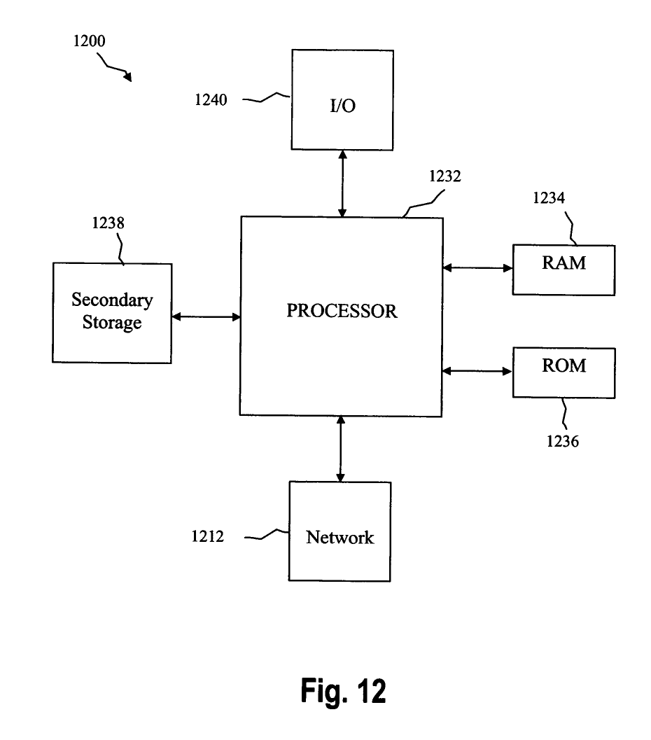

The systems and methods described above may be implemented on any computing system with sufficient processing power, memory resources, and network throughput capability to handle the necessary workload placed upon it. FIG. 12 illustrates a typical computing system suitable for implementing one or more embodiments disclosed herein. The computing system 1200 includes at least one processor 1220 (which may be referred to as a central processor unit or CPU) that is in communication with memory devices including secondary storage 1250, read only memory (ROM) 1240, random access memory (RAM) 1230, input/output (I/O) 1210 devices, and network connectivity devices 1260. The processor may be implemented as one or more CPU chips.

The secondary storage 1250 (i.e., data store) may be comprised of one or more disk drives or tape drives and is used for non-volatile storage of data and as an over-flow data storage device if RAM 330 is not large enough to hold all working data. Secondary storage 1250 may be used to store programs which are loaded into RAM 1230 when such programs are selected for execution. The ROM 1240 is used to store instructions and perhaps data which are read during program execution. ROM 1240 is a non-volatile memory device which typically has a small memory capacity relative to the larger memory capacity of secondary storage. The RAM 1230 is used to store volatile data and perhaps to store instructions. Access to both ROM 1240 and RAM 1230 is typically faster than to secondary storage 1250.

I/O 1210 devices may include printers, video monitors, liquid crystal displays (LCDs), touch screen displays, keyboards, keypads, switches, dials, mice, track balls, voice recognizers, or other well-known input devices. The network connectivity devices 1260 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other network devices. These network connectivity 1260 devices may enable the processor 1220 to communicate with an Internet or one or more intranets. With such a network connection, it is contemplated that the processor 1220 might receive information from the network, or might output information to the network in the course of performing the above-described method steps. Such information, which is often represented as a sequence of instructions to be executed using processor 1220, may be received from and outputted to the network, for example, in the form of a computer data signal embodied in a carrier wave.

Such information, which may include data or instructions to be executed using processor 1220 for example, may be received from and outputted to the network, for example, in the form of a computer data baseband signal or signal embodied in a carrier wave. The baseband signal or signal embodied in the carrier wave generated by the network connectivity 1260 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 1220 executes instructions, codes, computer programs, scripts which it accesses from hard disk, floppy disk, optical disk (these various disk based systems may all be considered secondary storage 1250), ROM 1240, RAM 1230, or the network connectivity devices 1260.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each but may still be indirectly coupled and in communication, whether electrically, mechanically, or otherwise, with one another. Other examples of changes, substitutions, and alterations are ascertainable by one skilled in the art and could be made without departing from the spirit and scope disclosed herein.

What is claimed is:

1. A coaching method, comprising:
receiving assessment data from a user;
using the assessment data and course selection rules to select a plurality of courses for the user; and
sending a plurality of electronic messages comprising course content from the plurality of courses to the user on a scheduled basis.

2. The coaching method of claim 1, further comprising providing a coaching home page for the user, the coaching home page comprising one or more of an interface for tracking actions, an interface for managing courses, an interface for connecting to a coach, and a course recommendation list.

3. The coaching method of claim 1, further comprising tracking user selected actions.

4. The coaching method of claim 3, further comprising:
monitoring a tracking status of the user selected actions; and
sending an electronic coaching message to the user based on the tracking status.

5. The coaching method of claim 1, further comprising:
receiving updated user assessment data;
using the updated assessment data and course selection rules to select a second plurality of courses for the user; and
sending a plurality of electronic messages comprising the second plurality of courses to the user on a scheduled basis.

6. The coaching method of claim 2, wherein an electronic message of the electronic messages comprises a link to an action the user can selectively add to an action list displayed in the graphical interface for tracking actions.

7. The coaching method of claim 1, further comprising sending messages between a user and a coach.

8. The coaching method of claim 1, further comprising providing a graphical coaching dashboard to a coach, the graphical coaching dashboard displaying data about the user.

9. The coaching method of claim 7, wherein the displayed data comprises one or more of: a profile of the user, the plurality of courses selected for the user, actions tracked by the user, and the assessment data.

10. The coaching method of claim 1, further comprising:
using the assessment data and course selection rules to select a plurality of recommended courses for the user; and
providing a list of the recommended courses to the user, wherein the user can selectively add a recommended course to the plurality of courses.

11. The coaching method of claim 10, further comprising:
receiving a plurality of new courses;
using the assessment data and course selection rules to select a second plurality of recommended courses for the user, wherein the second plurality of recommended courses comprises one or more courses of the plurality of new courses; and
updating the list of the recommended courses to include the second plurality of recommended courses.

12. The coaching method of claim 10, further comprising providing aggregate reports to a coaching provider, the reports comprising one or more of a usage breakdown report, an assessment breakdown report, and a live coach interaction report.

13. A coaching system, comprising:
a data store configured to store assessment data associated with a user and coaching course content; and
a coaching subsystem configured to send electronic coaching messages to the user, the coaching messages comprising lessons from a plurality of courses selected from the coaching course content using the assessment data and course selection rules.

14. The coaching system of claim 13, wherein the coaching subsystem is further configured to receive and track user-selected actions.

15. The coaching system of claim 14, wherein at least some of the electronic coaching messages comprise actions that the user may select to add to the user-selected actions.

16. The coaching system of claim 14, wherein the coaching subsystem is further configured to
monitor a tracking status of the user-selected actions, and
to send an electronic coaching message to the user based on the tracking status.

17. The coaching system of claim 13, wherein the coaching subsystem is further configured to provide a client dashboard for a coach, the client dashboard configured to allow a coach to view one or more of a profile of the user, the plurality of courses selected for the user, actions tracked by the user, and the assessment data.

18. The coaching system of claim 13, wherein the coaching subsystem is further configured to send electronic messages between a coach and the user.

19. The coaching system of claim 13, wherein the coaching subsystem is further configured to
select a plurality of recommended courses for the user using the assessment data and the course selection rules, and
add a recommended course of the plurality of recommended courses to the plurality of courses if the user requests that the recommended course be added.

20. The coaching system of claim 19, wherein the data store is further configured to store additional course content, and the coaching subsystem is further configured to
select a second plurality of recommended courses for the user using the assessment data and the course selection rules, the second plurality of recommended courses comprising one or more courses selected from the additional course content,
add a recommended course of the second plurality of recommended courses to the plurality of courses if the user requests that the recommended course be added.

21. The coaching system of claim 13, where in the data store is further configured to store updated assessment data associated with the user, and wherein the coaching subsystem is further configured to
select additional courses from the coaching course content using the updated assessment data and the course selection rules, and
add the additional courses to the plurality of courses.

22. The coaching system of claim 13, wherein the coaching subsystem is further configured to provide a coaching home page for the user, the coaching home page comprising one or more of an interface for tracking actions, an interface for managing courses, an interface for connecting to a coach, and a course recommendation list.

23. The coaching system of claim 13, wherein the coaching subsystem is further configured to generate aggregate reports for a provider of the coaching system, the aggregate reports comprising one or more a usage breakdown report, an assessment breakdown report, and a live coach interaction report.

24. The coaching system of claim 13, further comprising:
a memory that stores software comprising the coaching subsystem and the course selection rules; and
a processor coupled to the memory to execute the software.

25. A coaching system comprising:
a database tier comprising an interface to a database comprising course content, assessment data for one or more users, provider data for one or more providers, and coach data for one or more coaches;
a business logic tier operatively connected to the database tier and comprising coaching logic and business logic for managing the coaching system; and
a user interface tier operatively connected to the business logic tier; wherein the tiers of the coaching system interact to provide electronic coaching, live coaching, and peer coaching to the one or more users, and to generate aggregate reports of coaching system use for the one or more providers.

26. The coaching system of claim 25, wherein the electronic coaching comprises using the assessment data for a user of the one or more users and course selection rules to select a plurality of courses from the course content for the user, and sending electronic messages to the user on a scheduled basis, each electronic message comprising a lesson from one of the plurality of courses.

27. The coaching system of claim 26, wherein the electronic coaching further comprises recommending additional courses to the user, the additional courses selected using the assessment data of the user and the course selection rules, wherein the user may selectively add one or more of the additional courses to the plurality of courses.

28. The coaching system of claim 25, wherein the live coaching comprises providing a message system wherein a user can send requests for coaching support to a coach of the one or more coaches, and wherein the coach can send coaching messages to the user.

29. The coaching system of claim 28, wherein the live coaching further comprises providing a client dashboard for the coach, the client dashboard configured to allow the coach to view one or more of a profile of the user, a plurality of courses selected for the user based on the user's assessment data and course selection rules, actions tracked by the user, and the user's assessment data, and wherein the coach can add a course to the plurality of courses selected for the user.

30. The coaching system of claim 27, wherein the peer coaching comprises providing online discussion forums wherein the one or more users can interact electronically and providing matching of users based on buddy request data.
